(19) United States
(12) Patent Application Publication
(10) Pub. No.: US 2025/0097959 A1
(43) Pub. Date: Mar. 20, 2025

(54) COMMUNICATION APPARATUSES AND METHODS FOR TRANSMITTER RESTRICTIONS ON RESOURCE REPORTING FOR SIDELINK COMMUNICATION

(71) Applicant: Panasonic Intellectual Property Corporation of America, Torrance, CA (US)

(72) Inventors: Yang KANG, Singapore (SG); Hidetoshi SUZUKI, Kanagawa (JP); Hong Cheng Michael SIM, Singapore (SG); Xuan Tuong TRAN, Singapore (SG); Yoshihiko OGAWA, Kanagawa (JP)

(21) Appl. No.: 18/726,620

(22) PCT Filed: Dec. 22, 2022
(86) PCT No.: PCT/SG2022/050925

§ 371 Date: Jul. 3, 2024

(30) Foreign Application Priority Data
Jan. 6, 2022 (SG) 10202200149T

(51) Int. Cl. H04W 72/25; H04W 72/02

(52) U.S. Cl. CPC H04W 72/25; H04W 72/02

(57) ABSTRACT

Communication apparatuses and methods for providing radio resource selection and reporting for a sidelink (SL) communication are provided. The techniques disclosed here feature a method including determining, at a transmitting User Equipment (TX UE), a first set of candidate resources having a high priority from all resources for the SL communication. The, first set of candidate resources are determined based on at least a reference signal received power (RSRP) of the SL communication and a discontinuous reception (DRX) inactive time of a receiving UE (RX UE). The method also includes reporting a subset of all the resources to higher layers wherein the subset of all the resources meets a condition, and wherein the subset of all the resources includes ones of the first set of candidate resources that meet the condition.

### BACKGROUND

### 1. Technical Field

The present disclosure relates generally to radio access network (RAN) sidelink (SL) communication, and more particularly relates to communication apparatuses and methods for transmitter restrictions on resource reporting for SL communication.

### 2. Description of the Related Art

Communication apparatuses are prevalent in today's world in the form of phones, tablets, computers, cameras, digital audio/video players, wearable devices, game consoles, telehealth/telemedicine devices, and vehicles providing communication functionality, and various combinations thereof. The communication may include exchanging data through, for example, a cellular system, a satellite system, a wireless local area network system, and various combinations thereof.

In developing communication systems, it was realized that direct mode communication between User Equipment (UE) was desired. For example, in public safety communications, direct mode communication is essential to keep first responders connected, especially when there is no network coverage. Direct mode communication was developed in Third Generation Partnership Project (3GPP) Long Term Evolution (LTE) as sidelink (SL) communication. As 3GPP develops Fifth Generation (5G) communication protocols, SL communication will be adopted from LTE.

Discontinuous reception (DRX) with active times and inactive times has been introduced as an enhancement for SL communication between UEs to save power. However, currently it is only specified that the physical (PHY) layer selects and reports candidate resources to higher layers wherein at least a subset of the reported candidate resources are within an indicated DRX active time of the RX UE. There is no method or detailed procedures on how the PHY layer should restrict resources to derive the candidate resources and potential issues for resource selection and reporting are not addressed leaving a void in selection and restriction procedures in SL communication.

Thus, there is a need for communication apparatuses and methods for transmitter restrictions on resource reporting for SL communication to fill the void of resource selection and restriction procedures in present SL communication and enhance a TX UE's ability to select resources within a RX UE's indicated active time. Furthermore, other desirable features and characteristics will become apparent from the subsequent detailed description and the appended claims, taken in conjunction with the accompanying drawings and this background.

### SUMMARY

One non-limiting and exemplary embodiment facilitates providing methods and communication apparatuses to select and report resources for sidelink communication.

In an embodiment, the techniques disclosed herein feature a method of radio resource selection and reporting for a sidelink (SL) communication. The method includes determining, at a transmitting User Equipment (TX UE), a first set of candidate resources having a high priority from all resources for the SL communication. The, first set of candidate resources are determined based on at least a reference signal received power (RSRP) of the SL communication and a discontinuous reception (DRX) inactive time of a receiving UE (RX UE). The method also includes reporting a subset of all the resources to higher layers wherein the subset of all the resources meets a condition, and wherein the subset of all the resources includes ones of the first set of candidate resources that meet the condition.

It should be noted that general or specific embodiments may be implemented as a communication apparatus, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE FIGURES

In the following, exemplary embodiments are described in more detail with reference to the attached figures and drawings.

FIG. 1 shows an exemplary architecture for a 3GPP NR system;

FIG. 2 is a schematic illustration which shows functional split between NG-RAN and 5GC;

FIG. 3 is a sequence diagram for RRC connection setup/reconfiguration procedures;

FIG. 4 is a schematic illustration showing usage scenarios of Enhanced mobile broadband (eMBB), Massive Machine Type Communications (mMTC) and Ultra Reliable Low Latency Communications (URLLC);

FIG. 5 is a block diagram showing an exemplary 5G system architecture for a non-roaming scenario;

FIG. 6 depicts a flowchart of conventional New Radio (NR) candidate resource sensing procedures in 3GPP Release 16 (R16);

FIG. 7 depicts a flowchart of conventional Long Term Evolution (LTE) candidate resource sensing procedures in 3GPP Release 14 (R14);

FIG. 8 depicts a block diagram of an exemplary communication apparatus;

FIG. 9 depicts a flowchart for radio resource selection and reporting for SL communication in accordance with a first embodiment of the present disclosure;

FIG. 10 depicts a flowchart for radio resource selection and reporting for SL communication in accordance with a first variation of the first embodiment of the present disclosure;

FIG. 11 depicts a flowchart for radio resource selection and reporting for SL communication in accordance with a second variation of the first embodiment of the present disclosure;

FIG. 12 depicts a flowchart for radio resource selection and reporting for SL communication in accordance with a second embodiment of the present disclosure;

FIG. 13 depicts a flowchart for radio resource selection and reporting for SL communication in accordance with a third embodiment of the present disclosure;

FIG. 14 depicts a flowchart for radio resource selection and reporting for SL communication in accordance with a fourth embodiment of the present disclosure;

FIG. 15 depicts a flowchart for radio resource selection and reporting for SL communication in accordance with a fifth embodiment of the present disclosure;

FIG. 16 depicts a flowchart for radio resource selection for SL communication in accordance with a sixth embodiment of the present disclosure;

And FIG. 17 depicts a flowchart for radio resource selection for SL communication in accordance with a variation of the sixth embodiment of the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the exemplary embodiments or the application and uses of the exemplary embodiments. Furthermore, there is no intention to be bound by any theory presented in the preceding background or the following detailed description.

### 5G NR System Architecture and Protocol Stacks

3GPP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

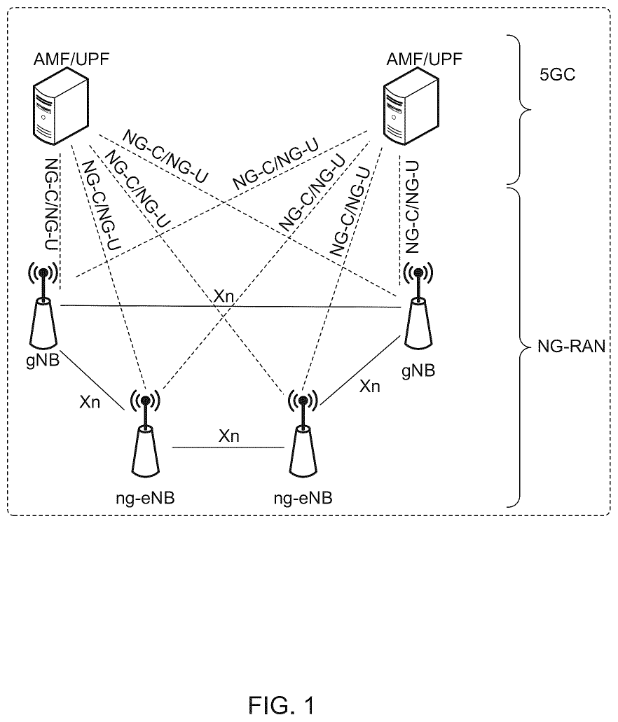

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink (DL) and 10 Gbps for uplink (UL)) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁵ within 1 ms). Finally, mMTC may preferably require high connection density (1,000,000 devices/km² in an urban environment), large coverage in harsh environments, and extremely long-life battery for low-cost devices (15 years).

Therefore, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

### 5G NR Functional Split Between NG-RAN and 5GC

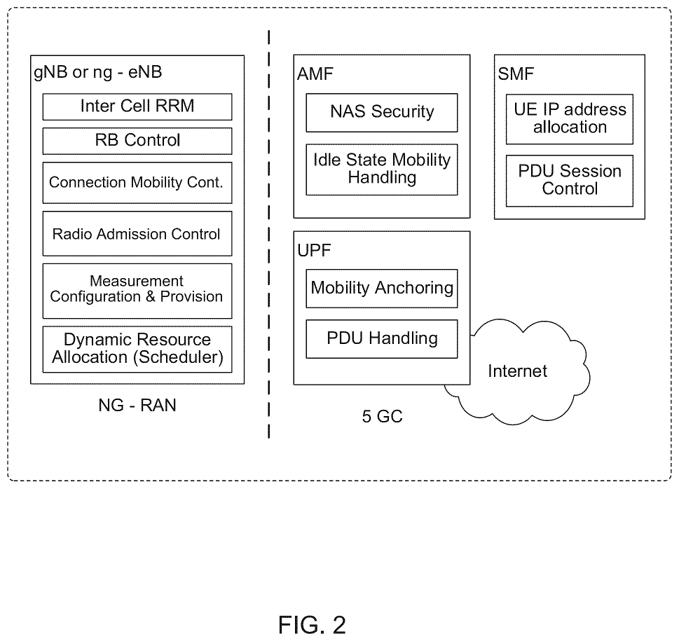

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

### RRC Connection Setup and Reconfiguration Procedures

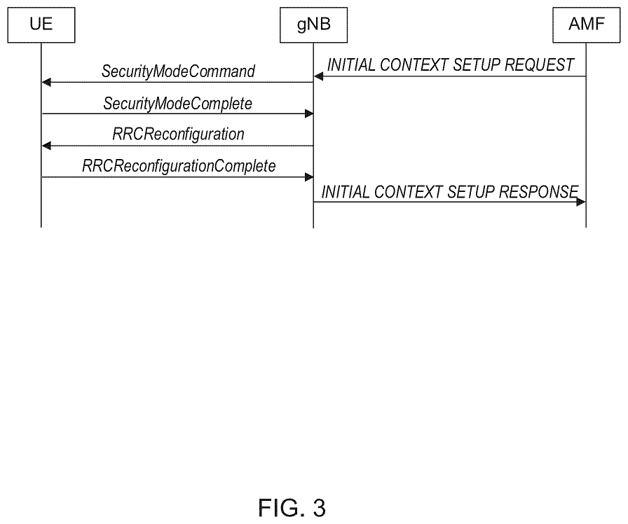

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signalling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

### Usage Scenarios of IMT for 2020 and Beyond

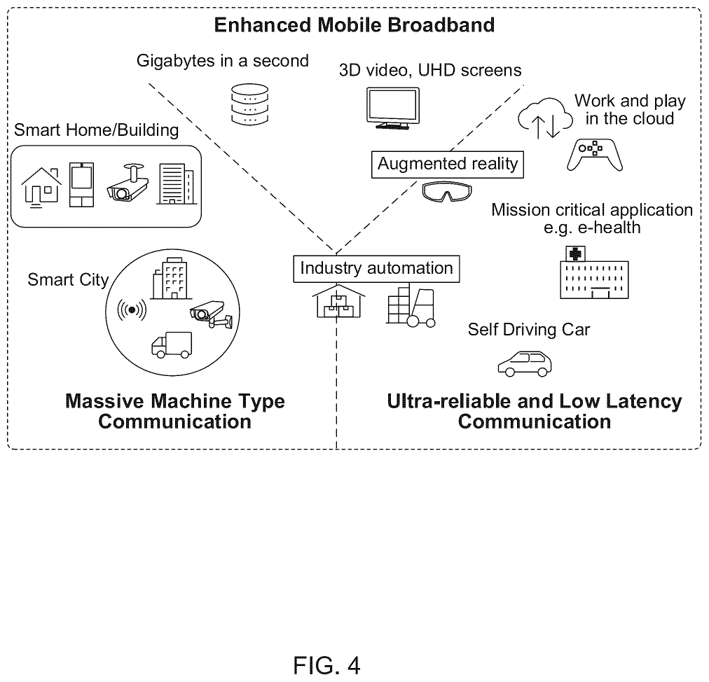

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

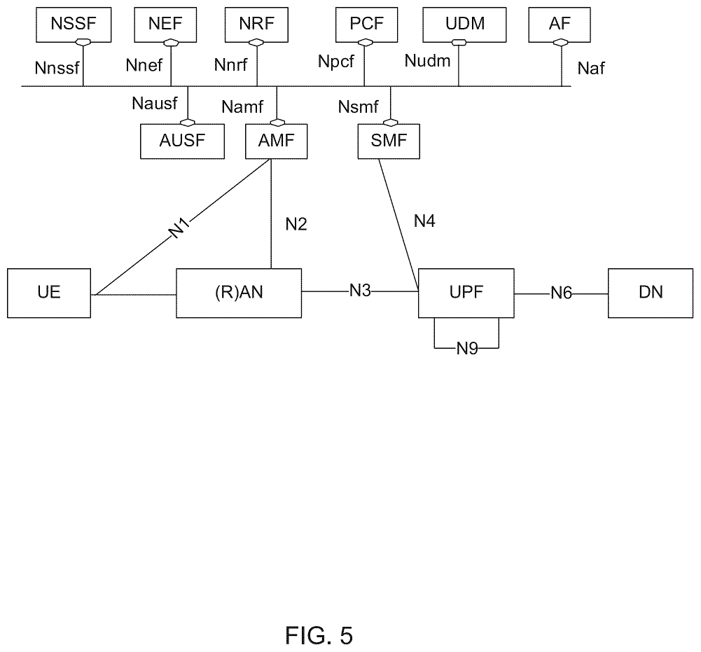

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF,UPF, etc.) of the 5GC to establish a PDU session including a radio bearer between a gNodeB and a UE in accordance with the QoS requirement and control circuitry, which, in operation, performs the services using the established PDU session.

### Embodiments

It is the intent of the present disclosure to present exemplary embodiments of communication apparatuses and methods for resource restriction for sidelink (SL) communication by classifying candidate resources with different priorities for resource reporting to the MAC layer of a transmitter User Equipment (TX UE). In addition, the present disclosure presents exemplary embodiments for methods of resource restriction by prioritizing candidate resources in an indicated active time within discontinuous reception (DRX) of SL communication at a receiver User Equipment (RX UE) which include, for example, incrementally increasing a threshold related to reference signal received power (RSRP) up to a maximum threshold or for a maximum number of iterations to optimize selecting resources available within a RX UE's indicated active time.

Within the 3GPP Technical Specification Group Radio Access Network (TSG RAN), 3GPP TSG RAN WG1 (RAN1) is responsible for specification of the physical (PHY) layer of radio interfaces for UE, Evolved UTRAN and NG-RAN. 3GPP TSG RAN WG2 (RAN2) is responsible for radio interface architecture and protocols such as MAC, RLC, PDCP, SDAP; the specification of Radio Resource Control protocols; and Radio Resource Management procedures.

In Release 17 (R17), discontinuous reception (DRX) with active times and inactive times was introduced as an enhancement for SL communication between UEs. While DRX was introduced into SL communication to save power, currently in RAN1, it is only specified that the PHY layer selects and reports candidate resources to higher layers wherein at least a subset of the reported candidate resources are within an indicated DRX active time of the RX UE. There is no method or detailed procedures on how the PHY layer to restrict resources to derive the candidate resources and potential issues for resource selection and reporting are not addressed.

RAN2 has discussed resource selection at the TX UE when communicating with RX UE(s) in DRX. Firstly, based on RAN2 agreements, RAN2 have the following understanding about the TX UE: (a) For unicast, the TX UE maintains a set of timers per pair of source Layer-2 ID and destination Layer-2 ID corresponding to the SL DRX timers in the RX UE, (b) for groupcast or broadcast, the TX UE maintains a set of timers per destination Layer-2 ID corresponding to the SL DRX timers in the RX UE, and (c) the TX UE uses the timers as part of the criterion for determining the allowable transmission time for each RX UE. For transmissions to RX UE(s) using SL DRX operation, logical channel prioritization (LCP) restrictions ensure that a TX UE transmits data in the active time of the RX UE(s).

Furthermore, in RAN2#115-e, RAN2 agreed to the following:
(i) When data is available for transmission to one or more RX UE in DRX, TX UE selects the resources taking into account the active time (current or future) of the RX UE(s) determined by the timers maintained at the TX UE, with further study on details and on whether RAN1 or RAN2 will implement this restriction.
(ii) For unicast, the TX UE selects the resources for the initial transmission associated with any active time (e.g., on duration timer or inactivity timer, or retransmission timer) at the RX UE, with further study on how to handle cases when a transmission may cause these timers to be running at the RX UE, on groupcast, and on whether any impact on the communication specification.
(iii) For unicast, the TX UE can select the resources for the retransmission associated with any active time (e.g., based on a duration timer or inactivity timer or based on a retransmission timer) at the RX UE, with further study on how to handle cases when a transmission may cause these timers to be running at the RX UE, on groupcast, and on whether any impact on the communication specification.
(iv) For broadcast, the TX UE can select the resources for the initial transmission associated with any active time supported by broadcast (i.e., ON duration) at the RX UE.
(v) And for broadcast, the TX UE can select the resources for the retransmission associated with any active time supported by broadcast (i.e., ON duration) at the RX UE.

RAN2 then asked RAN1 to take the above agreements into account and whether or how RAN1 intends to reflect the restriction in the first RAN2 agreement: “When data is available for transmission to one or more RX UE in DRX, the TX UE selects the resources taking into account the active time (current or future) of the RX UE(s) determined by the timers maintained at the TX UE”. In other words, on the candidate resources, for PHY to take into account the RX UE(s)' indicated DRX active time from MAC layer and whether or how to reflect the restriction of resources.

The following was concluded as a Working Assumption in RAN1#106bis-e meeting that a physical layer restriction would be applied when the PHY layer is indicated with an active time of RX UE: When the PHY layer is indicated with an active time of the RX UE from the MAC layer for candidate resource selection, a restriction is applied in the PHY layer so that at least a subset of candidate resources reported to the MAC layer is located within the indicated active time of the RX UE.

The following options are for further discussion in RAN1 to restrict resources for candidate resource selection taking into account the indicated active time from MAC layer:
Option 1: the PHY layer selects and reports candidate resources only within the indicated active time of the RX UE;
Option 2: the PHY layer selects and reports candidate resources in which at least a subset of the candidate resources is within the indicated active time of the RX UE; and
Option 3: the PHY layer selects and reports an additional candidate resource set of candidate resources within the indicated active time of the RX UE.

In the RAN1#107-e meeting, the following was further agreed for Option 2, that the PHY layer selects and reports candidate resources in which at least a subset of the candidate resources is within the indicated active time of the RX UE. When the SL DRX active time of the RX UE is provided by the higher layer for candidate resource selection (including resource (re)selection and re-evaluation/pre-emption checking), the following working assumption RAN1#106bis-e is confirmed for Option 2 as agreement:

When PHY layer is indicated with an active time of RX UE from MAC layer for candidate resource selection, a restriction is applied in PHY layer so that at least a subset of candidate resources reported to MAC layer is located within the indicated active time of the RX UE: Option 2: PHY layer selects and reports candidate resources in which at least a subset of the candidate resources is within the indicated active time of the RX UE. Additionally, the following options were left for further discussion to restrict resources for candidate resource restriction taking into account the indicated active time form the MAC layer: (a) details on when the number of subsets of candidate resource is less than a threshold, (b) whether the subset of candidate resource outside of the active time should consider each inactive time period, (c) UE selection of a resource selection window to overlap with the indicated RX UE active time, and (d) whether it is up to UE implementation to report candidate resources only within the indicated active time of the RX UE.

The problem, however, is that currently in RAN1, it is only specified that the PHY layer selects and reports candidate resources in which at least a subset of the candidate resources is within the indicated DRX active time of the RX UE. No detailed procedures or guidance have been provided on how the PHY layer should restrict such candidate resources. Moreover, some potential issues for resource selection and reporting are not addressed.

One possible skilled person's solution may be to have a pure MAC layer operation (i.e., no physical layer restriction) where the PHY layer would perform legacy procedures as TS38.214. After receiving reported candidate resource from the PHY layer, the MAC layer may only select within the RX UE(s) indicated active time in the reported candidate resources and the selected resource would be used for designated SL transmission. This pure MAC layer solution is less flexible as compared to a PHY layer solution as it only has a choice to select or not to select from a particular set of candidate resources. To segregate resources with different quality through measurements such as reference signal received power (RSRP) measurements of the SL communication cannot be achieved by the MAC layer.

Another possible solution is pure random selection from the candidate resources within the indicated RX UE(s)' active time. No complex procedures is needed for random selection. However, non-proper resources and noisy resources cannot be excluded in a pure random selection solution.

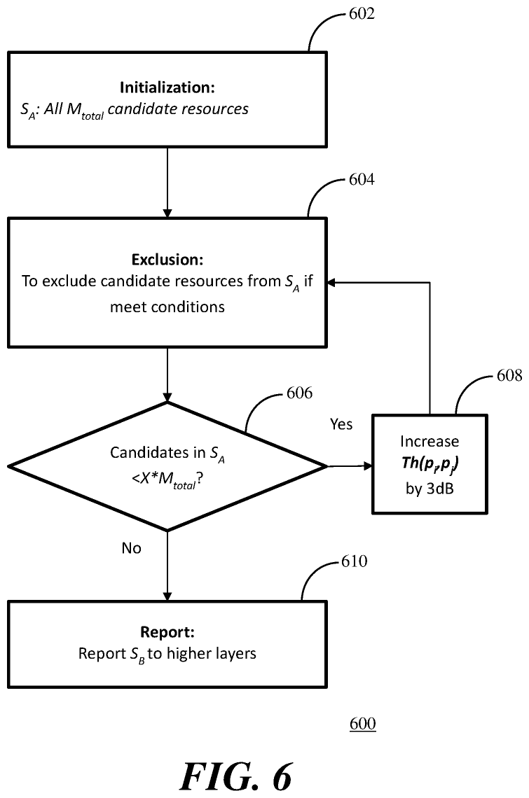

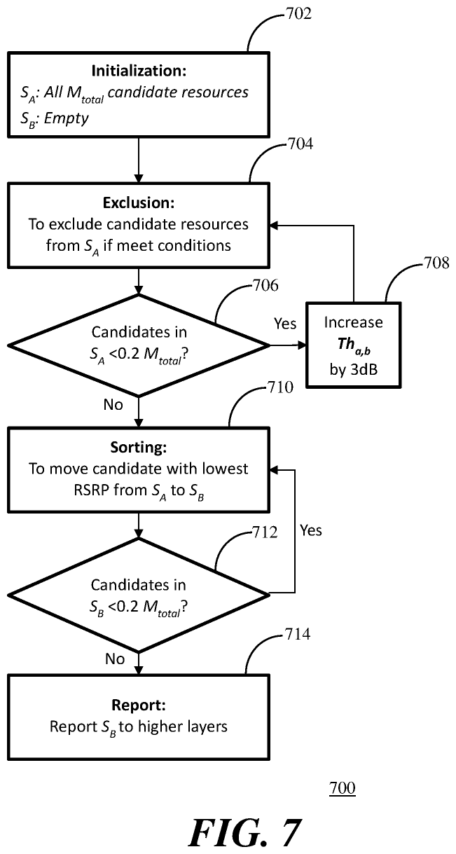

Referring to FIG. 6 and FIG. 7, conventional Fifth Generation (5G) and Fourth Generation (4G) candidate resource sensing procedures are illustrated. FIG. 6 depicts a flowchart 600 of conventional New Radio (NR) candidate resource sensing procedures for 5G in 3GPP Release 16 (R16). An initialization step 602, sets a term SA to equal a set of all Mₜₒₜₐₗ candidate resources. At step 604 some candidate resources are excluded from S_{A} if they meet certain conditions. Then it is determined at step 606 whether the remaining number of candidate resources are less than a percentage X of the total number of candidate resources (Mₜₒₜₐₗ). If the remaining number of candidate resources at step 606 is less than X*Mₜₒₜₐₗ, then a reference signal received power (RSRP) threshold Th(pᵢ, Pⱼ) is increased at step 608 by three decibels and the exclusion of candidate resources step 604 is repeated. When the remaining number of candidate resources at step 606 is not less than X*Mₜₒₜₐₗ, then the set of non-excluded candidate resources S_{B} is reported at step 610 to higher layers.

FIG. 7 depicts a flowchart 700 of conventional Long Term Evolution (LTE) candidate resource sensing procedures in 3GPP Release 14 (R14). An initialization step 702, sets a term S_{A} to equal a set of all Mₜₒₜₐₗ candidate resources and sets a term S_{B} to include no candidate resources. At step 704 some candidate resources are excluded from S_{A} if they meet certain conditions. Then it is determined at step 706 whether the remaining number of candidate resources in the set S_{A} are less than twenty per cent of the total number of candidate resources (Mₜₒₜₐₗ). If the remaining number of candidate resources in set S_{A} at step 706 is less than twenty per cent of Mₜₒₜₐₗ, then a threshold Th(a, b) is increased at step 708 by three decibels and the exclusion step 704 is repeated. When the remaining number of candidate resources in the set S_{A} at step 706 is not less than twenty per cent of Mₜₒₜₐₗ, then the candidate resources in the set S_{A} with lowest RSRP is moved from the set S_{A} to the set S_{B} at a sorting step 710. Step 712 determines whether the number of candidates in the set S_{B} is less than twenty per cent of Mₜₒₜₐₗ. The sorting step 710 is repeated until the number of candidates in the set S_{B} is not less than twenty per cent of Mₜₒₜₐₗ. When the remaining number of candidates in the set S_{B} is not less than twenty per cent of Mₜₒₜₐₗ at step 712, the set of candidate resources S_{B} is reported at step 714 to higher layers.

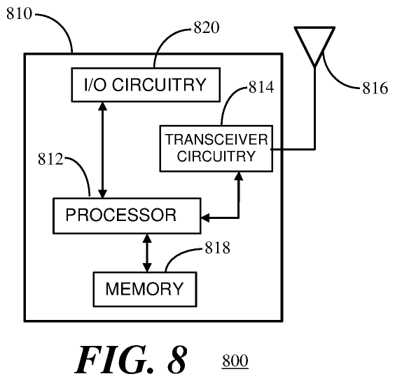

Referring to FIG. 8, a simplified block diagram 800 depicts an exemplary communication apparatus 810 such as a user equipment (UE) operating in a wireless communication system that transmits and receives communications between the user equipment and the communication network. In accordance with the present disclosure, the communication apparatus 810 is also capable of direct communication with other UE via sidelink (SL) communication. The communication apparatus 810 may include a device such as a processor 812 which is coupled to a wireless communication device, such as a transceiver 814, connected to an antenna 816 for performing a function of SL communication as described in the present disclosure. For example, the communication apparatus 810 may comprise the processor 812 that generates control signals and/or data signals which are used by the transceiver 814 to perform a communication function on a selected resource of the communication apparatus 810. The communication apparatus 810 may also comprise a memory 818 coupled to the processor 812 for storage of instructions and/or data for generation of the control signals and/or data signals by the processor 812. The communication apparatus 810 may also include input/output (I/O) circuitry 820 coupled to the processor 812 for receiving input of data and/or instructions for storage in the memory 818 and/or for generation of the control signals and/or data signals and for providing output of data in the form of audio, video, textual or other media. At least the processor 812 and the memory 818 can be collectively referred to as circuitry of the communication apparatus 810.

In accordance with the present disclosure, a method for restricting the candidate resources for reporting to higher layers is provided. For a SL communication TX UE with consideration of RX UE(s)' DRX information, restrictions would be applied to TX UE resources in accordance with different priorities for candidate resources during the TX UE candidate resource selection and reporting. The set S_{A} includes all TX UE resources while the set S_{R} includes candidate resources within the indicated DRX active time of a RX UE(s) of the TX UE's resource selection window. In accordance with the method of the present disclosure, a first set of candidate resources having the “best quality” (i.e., highest priority), such as the candidate resources within the indicated active time of RX UEs and under a threshold related to RSRP, are considered first. Accordingly, a method of radio resource selection and reporting for sidelink (SL) communication in accordance with the present disclosure includes determining, at the TX UE, a first set of candidate resources having a high priority from all resources for the TX UE SL communication. The, first set of candidate resources are determined based on at least a RSRP of the SL communication and a DRX inactive time of a RX UE. The method also includes reporting a subset of all the resources to higher layers, the subset of all the resources meeting a condition and including ones of the first set of candidate resources that meet the condition.

If the best quality/highest priority candidate resources are less than a pre-configured percentage of the number of all candidate resources, “second best quality” candidate resources, “third best quality” candidate resources, etc. that meet the condition are included in the subset of resources reported to the higher layers.

For a TX UE, when the PHY layer is indicated with an active time of the SL communication target RX UE, the candidate resources within S_{R} and below the threshold related RSRP as determined by sensing are considered as “best quality” candidate resources (i.e., the first set of candidate resources). The “best quality” candidate resources would be prioritized to be included into the set of candidate resources to be reported to MAC layer (i.e., the subset of all resources to be reported to higher layers). If not enough “best quality” resources, the “second best quality” candidate resources within S_{R} but above the threshold related to RSRP will also be included. For these “second best quality” candidate resources, more resources within S_{R} would result in less transmission failure due to RX UE(s)' DRX, but may feature higher in-air interference.

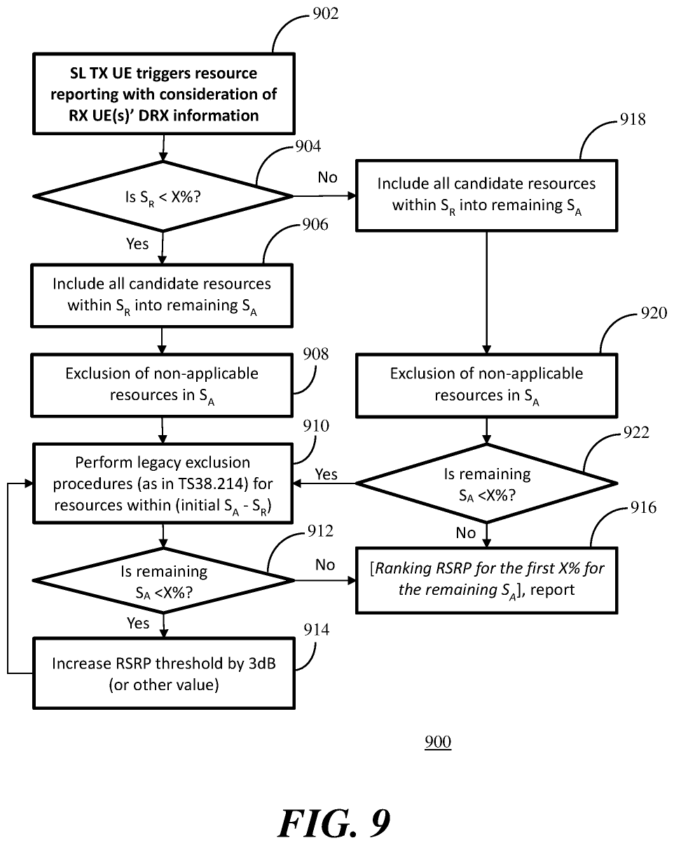

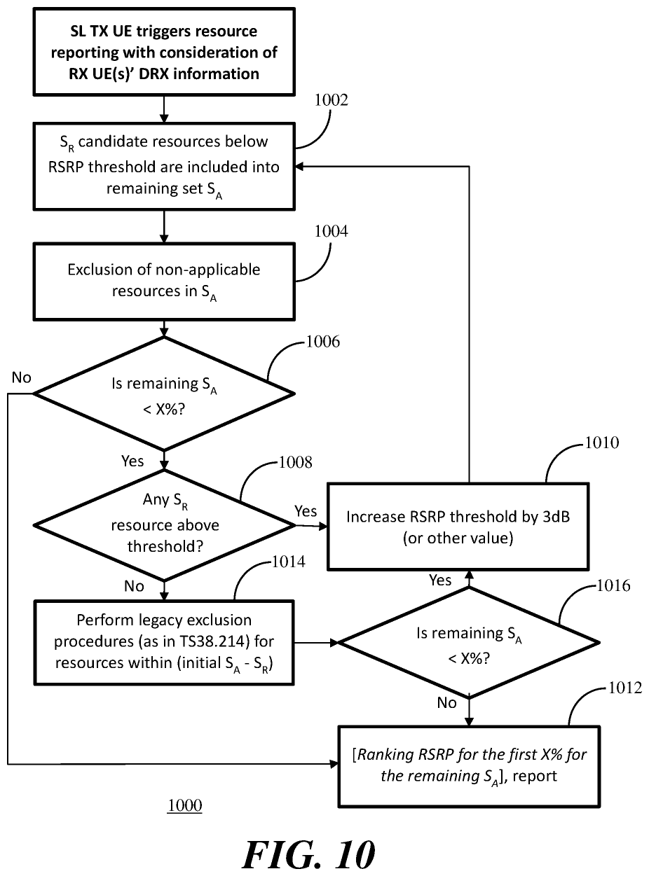

Referring to FIG. 9, a flowchart 900 depicts a first embodiment of a method of radio resource selection and reporting for SL communication in accordance with the present disclosure wherein the SL communication TX UE triggers 902 resource reporting with consideration of one or more RX UE(s)' DRX information. If S_{R} is less than pre-configured X % (e.g., defined in TS38.214 §8.1.4 as sl-TxPercentageList with values 20%, 35%, 50% as in r16 TS38.331 §6.3.5) of the initial set of candidate resources SA (all candidate resources), all candidate resources of S_{R} are included into S_{A} 906, exclusion steps are performed for non-applicable resources (e.g., pre-empted resources) in SA 908 which includes all candidate resources of S_{R,} and the legacy exclusion procedures (i.e., as in r16 TS38.214 §8.1.4, step 5&6) are performed for additional resources (i.e., initial S_{A} minus S_{R}) 910. When the number of resources in the non-excluded resources (i.e., the remaining resources after the exclusion step 908 and the legacy exclusion step 910) is less than the pre-configured X % of S_{A} 912, the legacy exclusion step 910 is iteratively performed to exclude further resources based on an increased threshold related to the RSRP where the threshold is increased by three decibels 914 (or other pre-configured increment value). Note that different increment values (i.e., pre-configured increment values) may apply in different iterations and/or in different steps and/or for different quality resources.

When the number of resources in the non-excluded resources is not less than the pre-configured X % of S_{A} 912, a subset of the set S_{A} comprising the non-excluded resources is reported 916 to the MAC layer with optionally ranking by RSRP the first X % of S_{A} reported.

If S_{R} is greater or equal to than X % of the initial S_{A} 904, all candidate resources of S_{R} are included into S_{A} 918, exclusion steps of non-applicable resources are performed 920 and it is determined 922 whether the non-excluded resources are less than X % of the initial S_{A}. If the number of non-excluded resources is not less than X % of the initial S_{A}, the non-excluded resources are reported 916. If the number of non-excluded resources in the remaining S_{A} is less than X %, the legacy exclusion step 910 is iteratively performed to exclude further resources based on an increased threshold related to the RSRP where the threshold is increased by three decibels 914 (or other pre-configured value). Thus, the flowchart 900 depicts a method of radio resource selection and reporting for SL communication in accordance with the present disclosure which, when less than X % of the initial S_{A} are not in a subset of resources to be reported, the threshold related to the RSRP is iteratively increased until the subset of resources includes X % or more resources.

Referring to FIG. 10, a flowchart 1000 for radio resource selection and reporting for SL communication in accordance with a first variation of the first embodiment of the present disclosure is depicted. For inclusion of “best quality” candidate resources within S_{R}, only candidate resources below the threshold relating to RSRP are included into remaining set S_{A} 1002. The exclusion step 1004 is performed for non-applicable resources in the remaining set S_{A} and if the candidate resources within S_{A} are still less than X % of all resources 1006, “second best quality” resources are included by determining whether any candidate resources within S_{R} are above the threshold 1008 and iteratively increasing the threshold 1010 until all resources in S_{R} are included 1008 or the candidate resources in the remaining S_{A} is greater or equal to than X % of all resources 1006. When the candidate resources in the remaining S_{A} are greater than or equal to X % of all resources 1006, the candidate resources in the remaining S_{A} are reported 1012 with optional ranking by RSRP for the first X % of the candidate resources in the remaining S_{A}.

If the candidate resources within S_{A} are still less than X % of all resources 1006 and there are no S_{R} resources above the threshold 1008, “third best quality” resources are included in the candidate resources in the remaining S_{A} by performing 1014 the legacy exclusion procedures for the set of additional resources (i.e., initial S_{A}-S_{R}) by iterations of RSRP increments 1010 until candidate resources with remaining S_{A} reaches X % of all resources S_{A} 1016. When the candidate resources in the remaining S_{A} are greater than X % of all resources S_{A} 1016, the candidate resources in the remaining S_{A} are reported 1012 with optional ranking by RSRP for the first X % of the candidate resources in the remaining S_{A}. In this manner, “best quality” resources, “second best quality” resources and “third best quality resources are included in the subset of resources reported, thereby prioritizing resources in the subset. An initial value of the threshold relating to RSRP may be different between “second best quality” and “third best quality” resources, or between resources having RX UE(s)' DRX active time and resources having RX UE(s)' DRX inactive time. The initial value of the threshold relating to RSRP for “second best quality” resources or RX UE(s)' DRX active time may be smaller or may be larger than that for “third best quality” resources or resources having RX UE(s)' DRX inactive time.

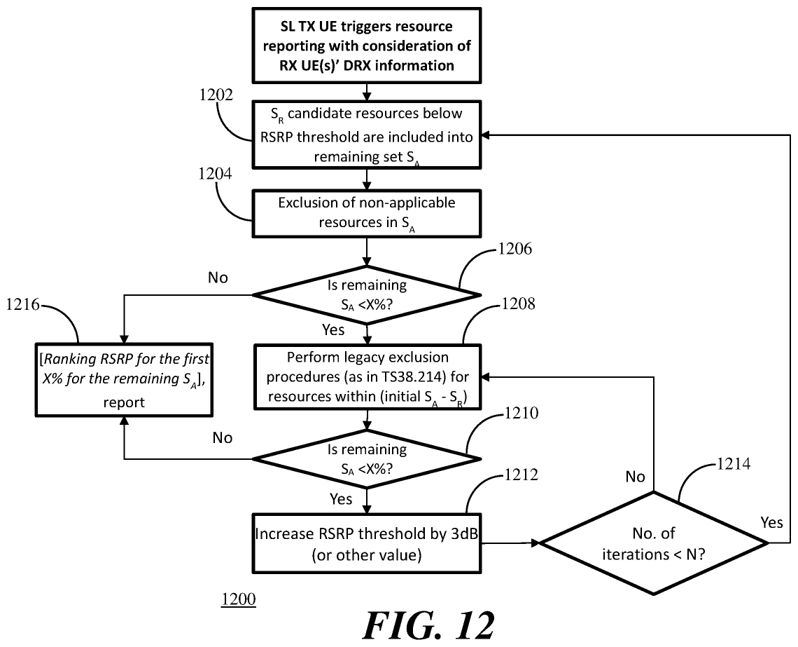

As a variation to the method of the flowchart 1000, instead of performing the step 1010 until no S_{R} resources are above the iteratively-increased threshold, step 1018 could be performed until no S_{R} resources are above the iteratively-increased threshold OR the step 1010 has been performed a maximum number of iterations (e.g., N iterations), this second variation not shown in the flowchart 1000 but discussed hereinbelow in regards to FIG. 12.

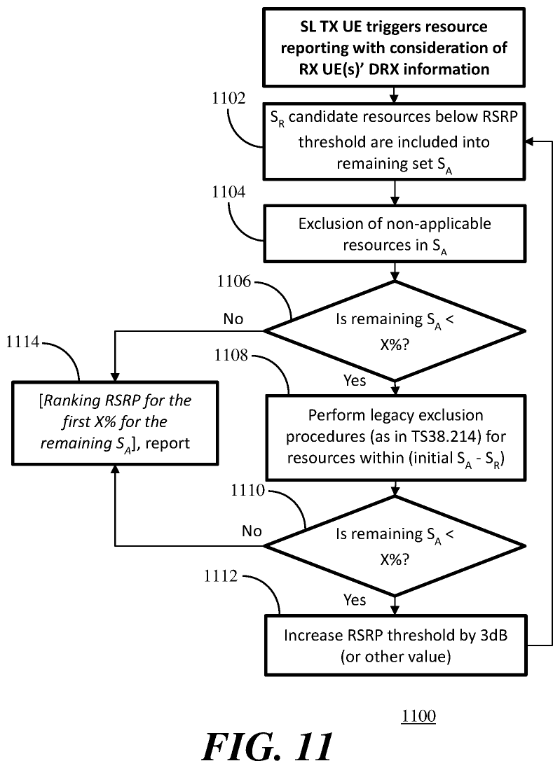

FIG. 11 depicts a flowchart 1100 of a second variation of the first embodiment of the present disclosure. For this second variation, the “second best quality” candidate resources are resources below the threshold related to RSRP but not within S_{R}. This definition of the “second best quality” candidate resources, advantageously reduces in-air interference due to limited RSRP, but may have more transmission failures due to transmissions which can be outside of the RX UE(s)' DRX active time.

For inclusion of “best quality” candidate resources within S_{R}, only candidate resources below the threshold relating to RSRP are included into remaining set S_{A} 1102. The exclusion step 1104 is performed for non-applicable resources in the remaining set S_{A} and if the candidate resources within S_{A} are still less than X % of all resources 1106, the legacy exclusion procedures are performed 1108 for the set of additional resources (i.e., initial S_{A}-S_{R}) to obtain “second best quality” candidate resources. If the candidate resources within S_{A} are still less than X % of all resources 1110, the threshold related to RSRP is increased by iterations of RSRP increments 1112 to obtain “third best quality” candidate resources until candidate resources with remaining S_{A} reaches X % of all resources S_{A} 1106, 1110. When the candidate resources in the remaining S_{A} are greater than X % of all resources S_{A} 1106, 1110, the candidate resources in the remaining S_{A} are reported 1114 with optional ranking by RSRP for the first X % of the candidate resources in the remaining S_{A}. Therefore, the “second best quality” candidate resources include resources below the threshold related to RSRP but not within S_{R}, which, while possibly increasing transmission failures due to transmissions which can be outside of the RX UE(s)' DRX active time, reduces in-air interference due to the limited RSRP.

Referring to FIG. 12, a flowchart 1200 depicts a second embodiment of the present disclosure. For this second embodiment, a maximum number of iterations of increased threshold is included which beneficially limits less noisy resources to be included in SR.

For inclusion of “best quality” candidate resources within S_{R}, only candidate resources below the threshold relating to RSRP are included into remaining set S_{A} 1202. The exclusion step 1204 is performed for non-applicable resources in the remaining set S_{A} and if the candidate resources within S_{A} are still less than X % of all resources 1206, the legacy exclusion procedures are performed 1208 for the set of additional resources (i.e., initial S_{A}-S_{R}) to obtain “second best quality” candidate resources. If the candidate resources within S_{A} are still less than X % of all resources 1210, the threshold related to RSRP is increased by iterations of RSRP increments 1212 to obtain “third best quality” candidate resources until a maximum number of iterations N 1214. If the number of iterations is less than N 1214, processing returns to step 1202. When the number of iterations is greater than or equal to N 1214, the legacy exclusion procedures are performed 1208 for the set of additional resources (i.e., initial S_{A}-S_{R}) to obtain “fourth best quality” candidate resources When the candidate resources in the remaining S_{A} are greater than X % of all resources S_{A} 1206, 1210, the candidate resources in the remaining S_{A} are reported 1216 with optional ranking by RSRP for the first X % of the candidate resources in the remaining S_{A}.

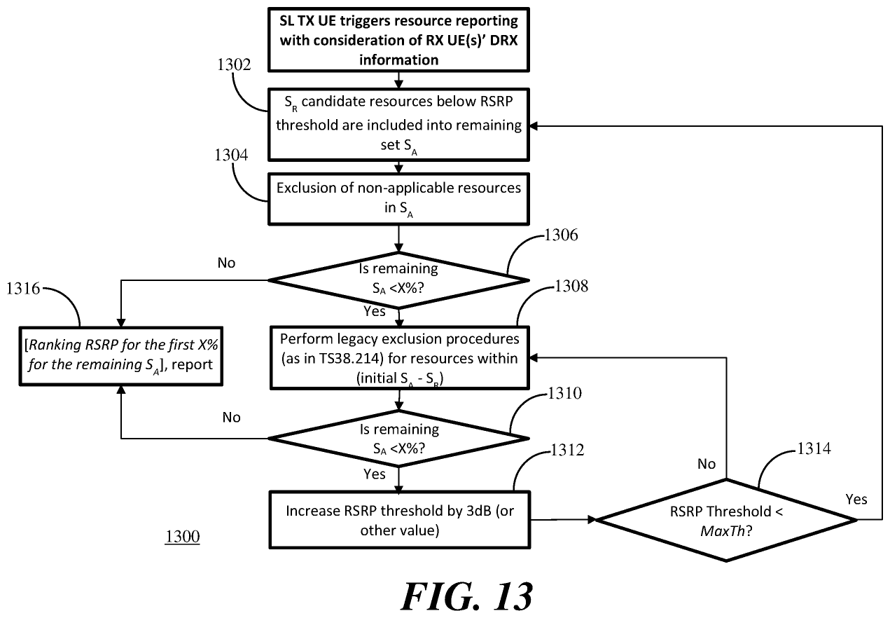

FIG. 13 depicts a flowchart 1300 of a third embodiment of the present disclosure. This third embodiment is similar to the second embodiment of FIG. 12 except that instead of a maximum number of iterations of increased threshold, a maximum threshold level of the threshold relating to RSRP is included which also provides the advantage of limiting less noisy resources to be included in S_{R}.

For inclusion of “best quality” candidate resources within S_{R}, only candidate resources below the threshold relating to RSRP are included into remaining set S_{A} 1302. The exclusion step 1304 is performed for non-applicable resources in the remaining set S_{A} and if the candidate resources within S_{A} are still less than X % of all resources 1306, the legacy exclusion procedures are performed 1308 for the set of additional resources (i.e., initial S_{A}-S_{R}) to obtain “second best quality” candidate resources. If the candidate resources within S_{A} are still less than X % of all resources 1310, the threshold related to RSRP is increased by iterations of RSRP increments 1312 to obtain “third best quality” candidate resources until a maximum threshold related to the RSRP MaxTh is reached 1314. If the threshold related to the RSRP is less than MaxTh 1314, processing returns to step 1302. However, when the threshold related to the RSRP is greater than or equal to MaxTh 1314, the legacy exclusion procedures are performed 1308 for the set of additional resources (i.e., initial S_{A}-S_{R}) to obtain “fourth best quality” candidate resources. When the candidate resources in the remaining S_{A} are greater than X % of all resources S_{A} 1306, 1310, the candidate resources in the remaining S_{A} are reported 1316 with optional ranking by RSRP for the first X % of the candidate resources in the remaining S_{A}.

Thus, by including a maximum number of iterations of increasing the threshold, inclusion of less noisy resources in S_{R} is limited. MaxTh may be configured for candidate resources having RX UE(s)' DRX active time and candidate resources having RX UE(s)' DRX inactive time, and a value of MaxTh may be different between them. The value of MaxTh for candidate resources having RX UE(s)' DRX active time may be smaller or may be larger than that for candidate resources having RX UE(s)' DRX inactive time.

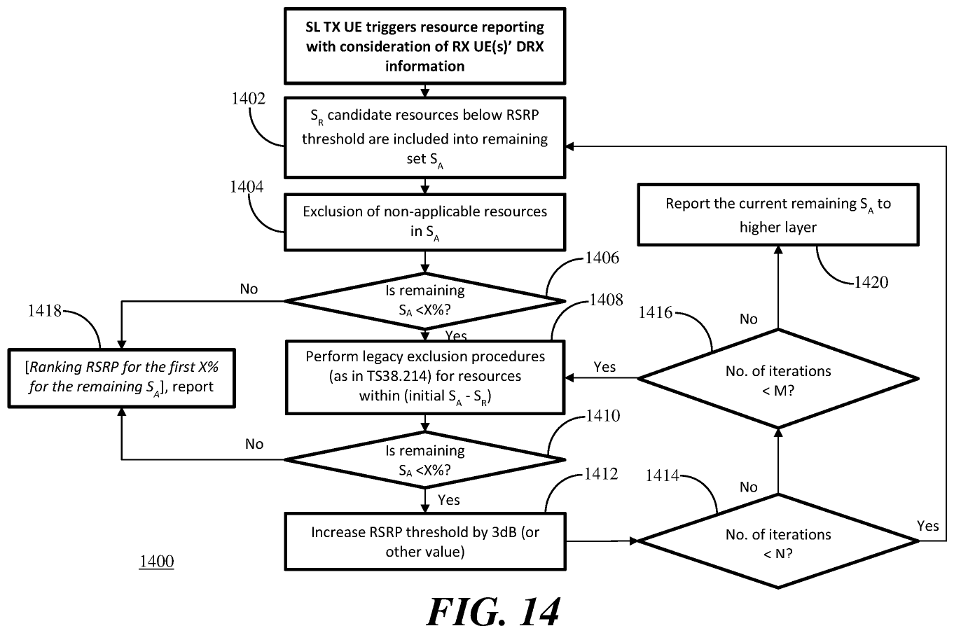

Referring to FIG. 14, a flowchart 1400 depicts a fourth embodiment of the present disclosure. For this fourth embodiment, the “best quality” candidate resources are considered without infinite iterations. This process also limits reporting of less noisy resources by limiting the maximum iterations.

For inclusion of “best quality” candidate resources within S_{R}, only candidate resources below the threshold relating to RSRP are included into remaining set S_{A} 1402. The exclusion step 1404 is performed for non-applicable resources in the remaining set S_{A} and if the candidate resources within S_{A} are still less than X % of all resources 1406, the legacy exclusion procedures are performed 1408 for the set of additional resources (i.e., initial S_{A}-S_{R}) to obtain “second best quality” candidate resources. If the candidate resources within S_{A} are still less than X % of all resources 1410, the threshold related to RSRP is increased by iterations of RSRP increments 1412 to obtain “third best quality” candidate resources until a first number of iterations N 1414. If the number of iterations is less than N 1414, processing returns to step 1402.

When the number of iterations is greater than or equal to N 1414, but less than a second number of iterations M 1416 (where M is greater than N), the legacy exclusion procedures are performed 1408 for the set of additional resources (i.e., initial S_{A}-S_{R}) to obtain “fourth best quality” candidate resources. When the candidate resources in the remaining S_{A} are greater than X % of all resources S_{A} 1406, 1410, the candidate resources in the remaining S_{A} are reported 1418 with optional ranking by RSRP for the first X % of the candidate resources in the remaining S_{A}. Also, when the number of iterations is greater than or equal to the second number of iterations M 1416, the candidate resources in the remaining S_{A} are reported 1420 with optional ranking by RSRP for the first X % of the candidate resources in the remaining S_{A}. By using multiple maximum iterations, addition levels of quality priority can be obtained. In addition, setting a maximum number of iterations allows the “best quality” candidate resources to be considered without infinite iterations and limits reporting of less noisy resources. The number of iterations may be configured for candidate resources having RX UE(s)' DRX active time and candidate resources having RX UE(s)' DRX inactive time, and the number of iterations may be different between them. The number of iterations for candidate resources having RX UE(s)' DRX active time may be smaller or may be larger than that for candidate resources having RX UE(s)' DRX inactive time.

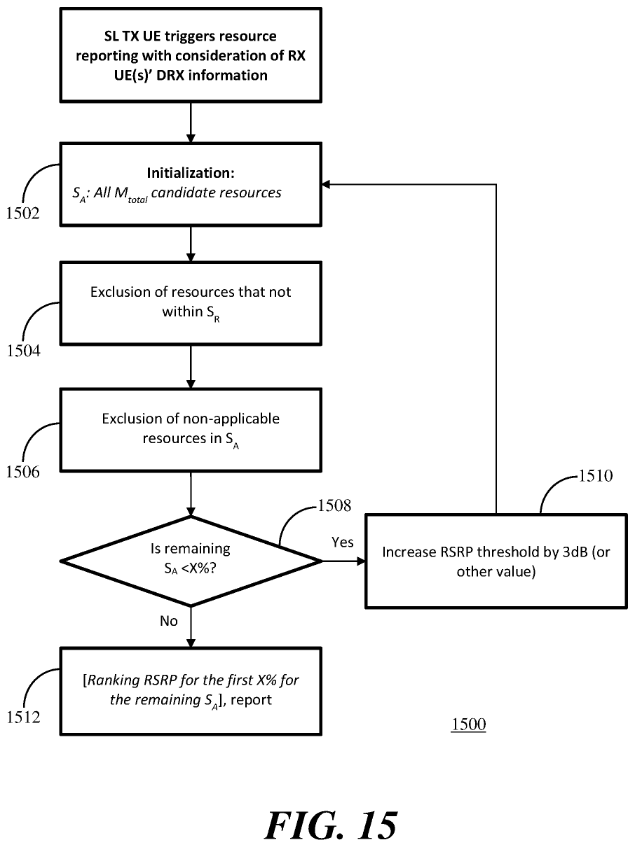

FIG. 15 depicts a flowchart 1500 of a fifth embodiment of the present disclosure. For this fifth embodiment, instead of inclusion resources to an empty set, the resources not within S_{R} are excluded from the initial set of resources S_{A}. The “second best quality” candidate resources are within S_{R} but above the threshold related to RSRP.

At an initialization step 1502, S_{A} is set to include all Mₜₒₜₐₗ candidate resources. For inclusion of “best quality” resources, candidate resources not within S_{R} are excluded from the initial set S_{A} 1504. The exclusion step 1506 is performed for non-applicable resources (e.g., pre-empted resources) in S_{A}. If the candidate resources within the set S_{A} are less than X % of the total number of candidate resources 1508, the threshold related to RSRP is iteratively incremented by, for example, three decibels 1510 and processing returns to step 1502 to obtain the “second best quality” candidate resources.

If the candidate resources in the remaining S_{A} are greater than the X % of the total number of candidate resources 1508, the remaining S_{A} are reported 1512 with optional ranking RSRP for the first X % for the remaining S_{A}. Note that the step 1504 of exclusion of non-S_{R} resources can be applied to the PHY approaches of the first to fourth embodiments discussed hereinabove. By excluding candidate resources not within S_{R} from the initial set S_{A}, the reported subset of resources will be with S_{R}.

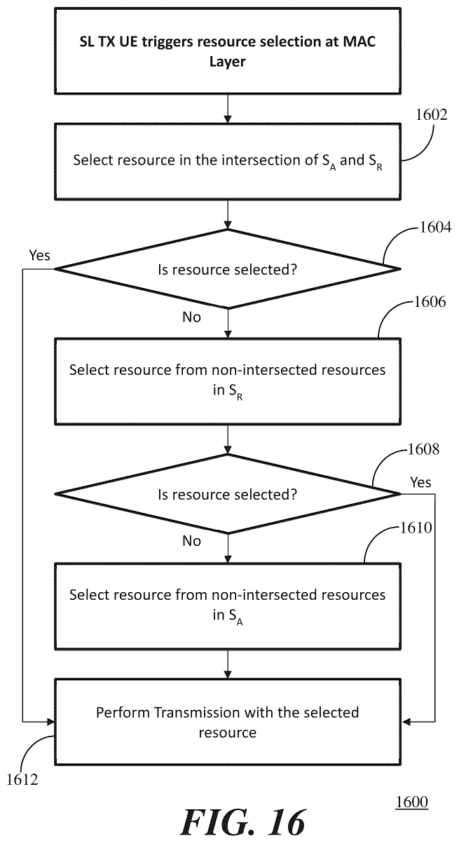

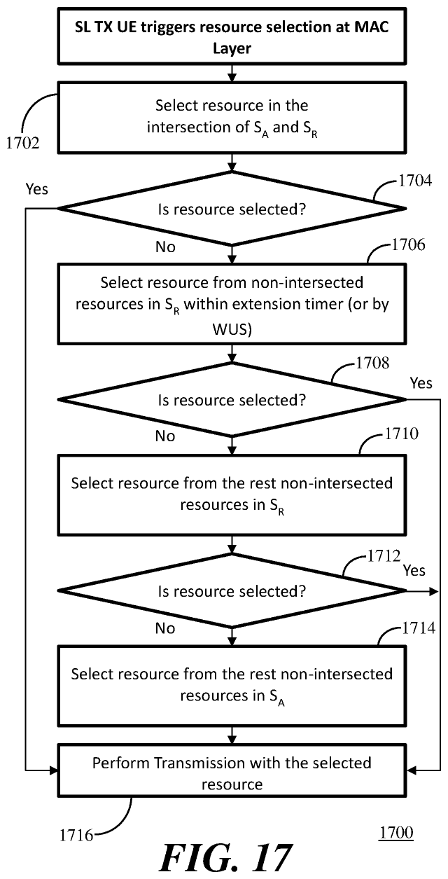

In accordance with the present disclosure, the RX UE(s)' DRX active time can be prioritized, after comparing the legacy reported set S_{A} with the candidate resources in S_{R}, by a two-step or a three-step selection performed at the MAC layer. This selection process can be performed in addition to any of the previous embodiments discussed hereinabove. Referring to FIG. 16, a flowchart 1600 for radio resource selection for SL communication in accordance with a sixth embodiment of the present disclosure is depicted, the sixth embodiment involving the two-step selection process performed at the MAC layer.

At step 1602, resources are selected in the intersection of S_{A} and S_{R}. If no resource is selected 1604, resources are selected 1606 from non-intersected resources in SR. If no resource is selected 1608, resources are selected 1610 from non-intersected resources in S_{A}. When a resource is selected 1604, 1608, 1610, SL communication transmission is performed 1612 with the selected resource.

FIG. 17 depicts a flowchart 1700 for radio resource selection for SL communication in accordance with a variation of the sixth embodiment of the present disclosure involving the three-step selection process performed at the MAC layer.

At step 1702, resources are selected in the intersection of S_{A} and S_{R}. If no resource is selected 1704, resources are selected 1706 from non-intersected resources in S_{R} which can be within an extension timer or by a wake-up signal (WUS). If no resource is selected 1708, resources are selected 1710 from the remainder of non-intersected resources in S_{R}. If no resource is selected 1712, resources are selected 1714 from the remainder of non-intersected resources in S_{A}. When a resource is selected 1704, 1708, 1712, 1714, SL communication transmission is performed 1716 with the selected resource

The above-described embodiments describe the basic reporting and/or selecting of candidate resources for SL communication in accordance with the present disclosure. However, the present disclosure is not limited to these embodiments. For example, the condition of maximum number of iterations in the fourth embodiment of FIG. 14 can be replaced by a maximum RSRP threshold level, or other potential conditions (e.g., CBR, CR). In addition, for embodiments two to four of FIG. 12 to condition of maximum number of iterations can be replaced by maximum RSRP threshold level, or other potential conditions (CBR, CR, etc.), a UE may skip from the PHY layer restriction when reaching a maximum number of RSRP increments (or other thresholds) and perform legacy candidate resource selection/reporting.

For all the embodiments, a maximum processing time could be designed (in unit of seconds, symbols or slots) so that a UE may skip from the PHY layer restriction and perform legacy candidate resource selection/reporting. Also, if the candidate resources in the remaining S_{A} is greater or equal to X % of the total resources, the UE may skip the ranking and report all the candidate resources within the remaining S_{A}. Further, for a UE configured with SL DRX, the initial RSRP threshold could be different from the default value without DRX configurations or the RSRP increment could be different from the default value which without DRX configurations. For a UE knowing RX UE(s) indicated DRX active time, the initial RSRP threshold could be different from the default value which without DRX configurations or the RSRP increment could be different from the default value without DRX configurations.

Also, note that while the term “candidate resource” has been used throughout the description hereinabove, the term “candidate resource” has the same meaning as “resource candidate”, “candidate single-slot resource”, “single-slot candidate resource”, “single-slot resource candidate” “candidate single-subframe resource”, “single-subframe candidate resource”, or “single-subframe resource candidate”.

Additionally, in relation to Rel.18 discussion of co-existence between LTE and NR sidelink in the same carrier, the DRX concept may be reused where the RX UE(s)' active time corresponds to NR sidelink exclusively used slots, and the RX UE(s)' non-active time corresponds shared slots with LTE or slot used only for LTE (or vice versa)

Further, for NR/LTE slots mapping to RX UE(s)' active/inactive time, the aforementioned embodiments can be applied solely in NR or LTE slots. Alternatively, for NR/LTE slots mapping to RX UE(s)' active/inactive time as a joint embodiment, some embodiments can be applied to NR slots and some (other) embodiments can be applied to LTE slots.

Thus, it can be seen that the exemplary embodiments in accordance with the present disclosure provide communication apparatuses and methods for reporting and selection of candidate resources for sidelink communication. In accordance with the present disclosure, an optimal solution of resource restriction is provided by classifying the candidate resources with different priorities (e.g., into “best quality”, “second best quality” and so on) for resource reporting to MAC layer. When making priorities of including candidate recourses indicated active time from RX UEs using RSRP thresholds increments, maximum RSRP thresholds and maximum number of iterations. By applying the solutions and procedures described by the present disclosure, the UE is advantageously able to select (or have a greater chance to select) resources within RX UE(s)' indicated active time (and also meet the required X % to report to higher layer).

The present disclosure can be realized by software, hardware, or software in cooperation with hardware. Each functional block used in the description of each embodiment described above can be partly or entirely realized by a LSI, such as an integrated circuit, and each process described in each embodiment may be controlled partly or entirely by the same LSI or a combination of LSIs. The LSI may be individually formed as integrated circuit chips, or one chip may be formed so as to include a part or all of the functional blocks. The LSI may include a data input and output coupled thereto. The LSI may be referred to as an integrated circuit (IC), a system LSI, a super LSI, or an ultra-LSI depending on a difference in the degree of integration. However, the technique of implementing an integrated circuit is not limited to the LSI and may be realized by using a dedicated circuit, a general-purpose processor, or a special purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. He present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more antennas.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”. The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus may also include an infrastructure facility, such as a base station, an access point, and any other apparatus, device or system that communicates with or controls apparatuses such as those in the above non-limiting examples.

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sildelink control information (SCI) or the 2nd stage SCI.

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

The present disclosure may be applied to any of a licensed band and an unlicensed band.

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

While exemplary embodiments have been presented in the foregoing detailed description of the present disclosures, it should be appreciated that a vast number of variations exist. It should further be appreciated that the exemplary embodiments are only examples, and are not intended to limit the scope, applicability, operation, or configuration of the present disclosure in any way. Rather, the foregoing detailed description will provide those skilled in the art with a convenient road map for implementing exemplary embodiments, it being understood that various changes may be made in the function and arrangement of the STA communication apparatus and/or the AP communication apparatus described in the exemplary embodiments without departing from the scope of the present disclosure as set forth in the appended claims.

1.-25. (canceled)

26. A communication apparatus, wherein the communication apparatus is a transmitting User Equipment (UE), the communication apparatus comprising:
a transceiver, which, in operation, performs a sidelink (SL) communication; and
circuitry, which, in operation,
determines a set of candidate resources based on a reference signal received power (RSRP) of the SL communication and a discontinuous reception (DRX) active time of a receiving UE; and
reports the set of candidate resources to a higher layer.

27. The communication apparatus in accordance with claim 26, wherein the set of candidate resources includes resources with a RSRP lower than a threshold related to RSRP.

28. The communication apparatus in accordance with claim 27, wherein, in case the set of candidate resources does not meet a defined condition, the threshold related to RSRP is increased and the set of candidate resources includes resources with a RSRP below the increased threshold.

29. The communication apparatus in accordance with claim 26, wherein, in case the set of candidate resources does not meet a defined condition, after determining the set of candidate resources based on the RSRP, the set of candidate resources is determined by including resources within the DRX active time of the receiving UE.

30. The communication apparatus in accordance with claim 26, wherein determining the set of candidate resources comprises indicating, to a physical (PHY) layer, the DRX active time of the receiving UE.

31. The communication apparatus in accordance with claim 26, wherein, in case a number of resources in the set of candidate resources is less than a defined percentage of a total number of all resources, the set of candidate resources is set to include all the resources.

32. The communication apparatus in accordance with claim 26, wherein, in case the set of candidate resources meets a defined condition, the transmitting UE excludes non- applicable resources from the set of candidate resources.

33. The communication apparatus in accordance with claim 26, wherein the set of candidate resources is determined from resources within a resource selection window of the transmitting UE.

34. The communication apparatus in accordance with claim 26, wherein, in case a number of resources in the set of candidate resources is less than a defined percentage of a total number of all resources, an operation to exclude resources from all the resources is iteratively performed so long as the number of resources in the set of candidate resources is less than the defined percentage of the total number of all resources.

35. The communication apparatus in accordance with claim 34, wherein the operation to exclude the resources is iteratively performed based on an increased threshold related to RSRP so long as the increased threshold is less than a maximum RSRP threshold level.

36. The communication apparatus in accordance with claim 26, wherein reporting the set of candidate resources to a higher layer comprises reporting the set of candidate resources to a media access control (MAC) layer.

37. The communication apparatus in accordance with claim 26, wherein the set of candidate resources includes a resource within the DRX active time of the receiving UE and a resource not within the DRX active time of the receiving UE.

38. The communication apparatus in accordance with claim 26, wherein determining the set of candidate resources comprises obtaining one or more resources within the DRX active time of the receiving UE.

39. The communication apparatus in accordance with claim 38, wherein, in case no resource is selected to be included in the set of candidate resources, the one or more resources within the DRX active time of the receiving UE are obtained.

40. The communication apparatus in accordance with claim 26, wherein a number of resources in the set of candidate resources is different between a transmitting UE with DRX configuration and a transmitting UE without DRX configuration.

41. The communication apparatus in accordance with claim 26, wherein the DRX active time of the receiving UE is provided by the higher layer.

42. A method performed by a transmitting User Equipment (UE), the method comprising:
performing a sidelink (SL) communication; and
determining a first set of candidate resources based on a reference signal received power (RSRP) of the SL communication and a discontinuous reception (DRX) active time of a receiving UE; and
reporting the set of candidate resources to a higher layer.

43. A communication apparatus, wherein the communication apparatus is a receiving User Equipment (UE), the communication apparatus comprising:
a transceiver, which, in operation, performs a sidelink (SL) communication; and
a receiver, which, in operation, receives data from a transmitting UE based on a set of candidate resources, wherein the set of candidate resources is determined based on a reference signal received power (RSRP) of the SL communication and a discontinuous reception (DRX) active time of the receiving UE.
